(19) United States
(12) Patent Application Publication
(10) Pub. No.: US 2008/0152272 A1
(43) Pub. Date: Jun. 26, 2008

(54) INSTRUMENTED ROLLING BEARING DEVICE

(76) Inventors: Franck Debrailly, Nouzilly (FR); Vincent Sausset, Tours (FR); Loic Abgrall, Tours (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 11/952,274

(22) Filed: Dec. 7, 2007

(30) Foreign Application Priority Data
Dec. 15, 2006 (FR) FR 0655556

(51) Int. Cl. F16C 32/00; B21D 53/10

(52) U.S. Cl. 384/448; 29/898

(57) ABSTRACT

Instrumented rolling bearing device for measuring the rotation parameters of the bearing, including a rotating race, a non-rotating race, at least one row of rolling elements placed between the non-rotating and rotating races, a rotating coder and a pliable non-rotating electronic circuit board comprising at least one sensor and at least one flat folded zone supporting the said sensor and pressing on a rigid reference surface forming part of a sensor block, at least one sensor being in the form of a spot-type detector cell.

### BACKGROUND OF THE INVENTION

1. Field of the Invention

The present invention relates to the field of instrumented rolling bearings furnished with a device for detecting the rotation parameters of the rolling bearing such as the angular position, the angular speed, or the angular acceleration of the rotating portion.

2. Description of the Relevant Art

Such rolling bearings usually use a coder ring fixed to the rotating portion, for example a multipolar ring and one or more sensors placed axially or radially opposite the active portion of the coder ring, for example Hall effect cells. The sensors are fixed to a rigid printed circuit board usually perpendicular to the axis of rotation of the rolling bearing. If a minimum axial space requirement of the rolling bearing is desired while obtaining a stable and repetitive output signal, it is possible to make use of the great radial rigidity of the rolling bearing and provide a radial air gap between the coder and the sensor, see document FR-A-2 882 139.

In this case, certain technical points are difficult. The sensor must be positioned radially with great precision relative to the coder, which is difficult and assumes that the sensor rests on a reference surface itself positioned with precision relative to the coder. It is often necessary to have recourse to resin attachment of the sensor on its support to hold it in the appropriate position, which is a costly operation. Furthermore, the connection lugs of the sensor are placed perpendicular to the rigid printed circuit board and traverse the board through small holes to emerge on the other side where the lugs are soldered to the circuit, the protruding portion of the lugs then being cut off. Here again, these operations are costly.

Document FR 2 655 735 describes a sensor including a conductor, shaped in meanders on a printed circuit, bonded to a stator. The conductor consists of a strand sandwiched between two insulating films. This type of sensor of the inductive type does not provide a sufficiently powerful and precise signal to suit all industrial applications.

### SUMMARY OF THE INVENTION

In an embodiment, a speed sensor device supplies a signal that is precise and stable over time in a very small axial space requirement and for a reasonable cost.

According to one embodiment, an instrumented rolling bearing device for measuring the rotation parameters of the bearing includes a rotating race, a non-rotating race, at least one row of rolling elements placed between the non-rotating and rotating races, a rotating coder and a non-rotating electronic circuit board supporting at least one sensor. The electronic circuit board is pliable and includes at least one flat folded zone supporting the said sensor and pressing on a rigid reference surface forming part of a sensor block, at least one sensor being in the form of a spot-type detector cell.

The fact that the electronic circuit board is pliable makes it possible to precisely adjust the zone of the board supporting the sensor on the reference surface, hence a precise positioning of the sensor. In addition, the arrangement of the sensor on the flat portion of the board makes it possible to obtain a precise and sound positioning. This provides a sensor supplying a signal that is precise and stable over time.

“Spot-type detector cell” here means a cell occupying a limited angular sector. In other words, the cell extends angularly in a limited manner in the circumferential direction about the axis of rotation of the rolling bearing. The sensor therefore includes two distinct ends separated by a certain distance in the circumferential direction.

The electronic circuit board is formed so as to obtain locally a flat portion that forms an angle with the adjacent portion of the board and on which at least one sensor is mounted.

In one embodiment, the electronic circuit board also includes electronic components for processing the signal transmitted by the sensor or sensors. The electronic components and the sensor or sensors may be placed on one and the same face of the electronic circuit board. Alternatively, the electronic components, on the one hand, and the sensor or sensors, on the other hand, are placed on opposite faces of the electronic circuit board.

In one embodiment, the electronic circuit board also includes a connector placed on one and the same face as the sensor or sensors or on the opposite face.

In one embodiment, the zone supporting the sensor is fixed to the reference surface by bonding.

In one embodiment, the zone supporting the sensor is fixed to the reference surface by mechanical retention. The pliable zone supporting the sensor may be fixed to the reference surface by a clip. The clip may be in the form of a piece of metal sheet curved in the shape of a C or in the shape of an Ω.

In one embodiment, the device includes a sensor block fixed to the non-rotating race and supporting the electronic circuit board. The sensor block may include a cap and an intermediate support furnished with at least one reference surface for the sensor or sensors. The cap may be furnished with at least one element for positioning and retention of the intermediate support and of the electronic circuit board.

The sensor block may be furnished with at least one reference surface for the sensor or sensors and with at least one element for positioning and retention of the electronic circuit board.

In one embodiment, the electronic circuit board is, after installation in the sensor block, in the form of a radial ring furnished with at least one axial lug forming a zone of support for the sensor. Alternatively, the electronic circuit board may be, after installation in the sensor block, in the form of an axial ring that is open or has joined ends. “Axial ring” means a ring having an axial dimension greater than its radial dimension. The radial dimension may correspond to the thickness of the electronic circuit board and the axial dimension to its width. The electronic circuit board may include bent portions and straight portions, the straight portions being furnished with reinforcements. The reinforcements may form enlarged thicknesses. The device may include at least two rows of sensors placed in distinct radial planes. It is therefore possible to assign one row of sensors to a first coder and the other row of sensors to a second coder for the purpose of carrying out two distinct detections, for example on two rolling bearings.

The method of manufacturing an instrumented rolling bearing device for measuring the rotation parameters includes a rotating race, a non-rotating race, a row of rolling elements placed between the rotating and non-rotating races, a rotating coder and an electronic circuit board including at least one sensor. The said at least one sensor is fixed to the electronic circuit board, the electronic circuit board is formed by folding and the said electronic circuit board is installed in a sensor block, a flat folded zone of the electronic circuit board supporting a sensor pressing on a rigid reference surface of the sensor block. The sensor may be fixed to the electronic circuit board by soldering.

In one embodiment, the electronic circuit board is fixed to the sensor block by material spinning of a portion of the sensor block.

In one embodiment, the said at least one sensor is fixed to a single face of the electronic circuit board.

In one embodiment, the zone of the electronic circuit board supporting the sensor is bonded to the reference surface.

In another embodiment, the zone of the electronic circuit board supporting the sensor is clipped to the reference surface.

The sensor is capable of supplying a signal that is precise, reliable and stable over time and of doing so with a reduced axial space requirement and a low cost.

### BRIEF DESCRIPTION OF THE DRAWINGS

The present invention will be better understood on reading the detailed description of a particular embodiment, taken as an example that is in no way limiting, and illustrated by the appended drawings in which:

FIG. 1 is a front view in elevation of an electronic circuit board according to one embodiment;

FIG. 2 is a side view in elevation of the electronic circuit board of FIG. 1;

FIG. 3 is a rear view in elevation of the electronic circuit board of FIG. 1;

FIG. 4 is an exploded view in perspective of a sensor block furnished with an electronic circuit board;

FIG. 5 is a view in perspective in the installed state of the sensor block of FIG. 4;

FIG. 6 is a view in axial section of a rolling bearing fitted with the sensor block of FIG. 5;

FIGS. 7 to 11 are views corresponding respectively to FIGS. 1 to 5 of an electronic circuit board and a sensor block according to another embodiment;

FIGS. 12 and 13 are views corresponding respectively to FIGS. 4 and 5 of a sensor block according to another embodiment;

FIG. 14 is a view in perspective of the clip of the sensor block of FIGS. 12 and 13;

FIG. 15 is a front flattened view of an electronic circuit board according to another embodiment;

FIG. 16 is a side view in elevation of the electronic circuit board of FIG. 15;

FIG. 17 is a view in perspective of the formed electronic circuit board of FIG. 15;

FIG. 18 is a view in perspective of a sensor block furnished with the electronic circuit board of FIG. 17;

FIG. 19 is a view in axial section of a rolling bearing fitted with the sensor block of FIG. 18; and

FIGS. 20 to 24 are views corresponding respectively to FIGS. 15 to 19 according to another embodiment.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

Generally in what follows, the reference numbers of similar elements have been retained from one figure to the next.

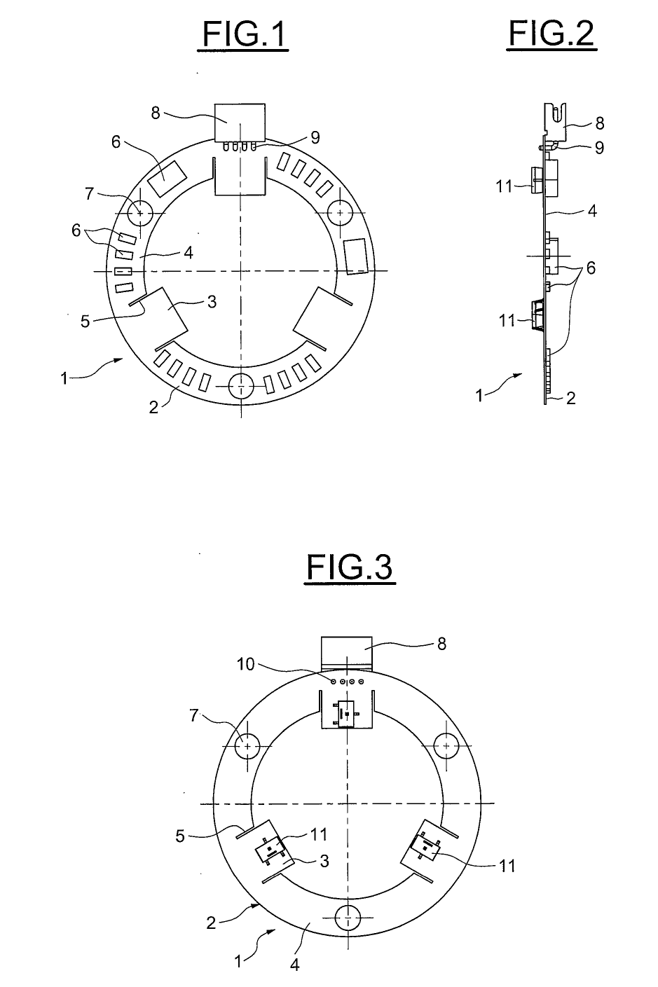

As illustrated in FIGS. 1 to 3, the electronic circuit board 1 includes a printed circuit 2 of the flexible and pliable type, for example including a polyamide-based substrate and one or more conducting layers. The printed circuit 2 has the general shape of an annular disc furnished with three tabs 3 extending radially towards the inside of the disc, cut-outs 4 being arranged between two sides of a tab 3 and the rest of the annular disc so that the rectangular-shaped tab 3 is connected only by one side to the annular disc 4, particularly the side opposite to the centre of the annular disc 4. The cut-outs 5 are preferably parallel with one another for each tab 3.

The printed circuit 2 supports electronic components 6 placed on the annular disc 4, for example by automated mounting with surface fixing. Three through-holes 7 are arranged in the annular disc 4 and are evenly distributed circumferentially while alternating with the tabs 3. The electronic circuit board 1 also includes a connector 8 protruding radially outwards in line with a tab 3. For the purpose of a particularly robust attachment, the connector 8 may be fixed by lugs 9 protruding into holes 10 of the printed circuit 2, see FIGS. 2 and 3. The electronic circuit board 1 also includes three sensors 11, each fixed to a tab 3, for example by surface-mounting. The sensors 11 may be of the magneto-sensitive type, for example a Hall effect cell. The sensors 11, shown in FIG. 3, are mounted on the face of the printed circuit 2 opposite to the face supporting the electronic components 6.

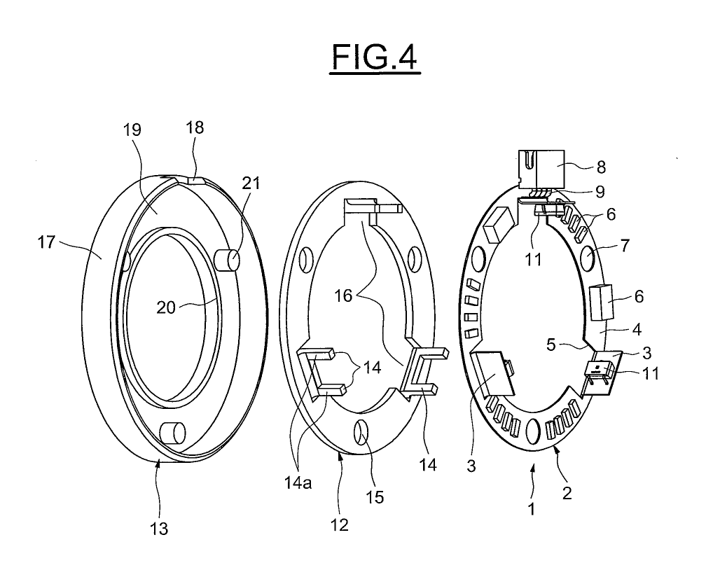

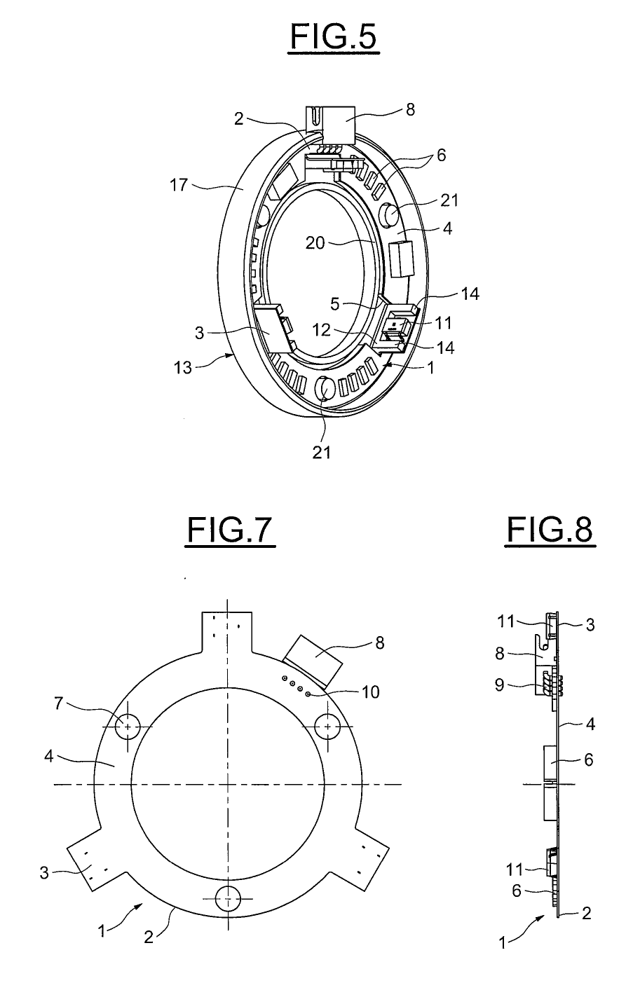

In FIGS. 1 to 3, the electronic circuit board 1 is shown in an intermediate state, the tabs 3 being directed radially inwards. The tabs 3 are then folded to have a flat axial shape that can be seen in FIGS. 4 and 5. The folding of the tabs 3, from the original radial position to the final axial position may be carried out by a machine furnished with a tool, which may or may not be a heating tool, provided for this purpose. The sensors 11 face inwards.

The sensor block that can be seen in FIGS. 4 and 5 includes an intermediate support 12 and a cap 13 able to interact with the electronic circuit board 1 for the purpose of an angular indexation of these two elements. The intermediate support 12 has the shape of a part, for example made of synthetic material such as a polyamide, of generally annular shape corresponding to that of the disc 4. The intermediate support 12 is furnished with three pairs of lugs 14 extending axially. The lugs 14 of a pair of lugs are situated relative to one another at a distance greater than the width of the sensor 11 and of its attachment pins. The axial length of the lugs 14 is substantially equal to that of the tabs 3.

Arranged in the intermediate support 12 are three through-holes 15 evenly distributed circumferentially and alternating with the pairs of lugs 14 with a position and a diameter corresponding to the holes 7 of the electronic circuit board 1. Notches 16 are also arranged in the intermediate support 12 radially inside the lugs 14. The notches 16 correspond to the notches delimited by the cut-outs 5 after the tabs 3 are folded.

During the assembly of the electronic circuit board 1 and of the intermediate support 12, the face of the electronic circuit board that can be seen in FIG. 3, opposite to that supporting the electronic components 6, comes into contact with a radial face of the intermediate support 12. Each pair of lugs 14 passes on either side of a sensor 11 and comes to form a flat rigid reference surface 14a for the tabs 3 supporting the sensors 11. The lugs 14 thereby give the tabs 3 a satisfactory rigidity.

The cap 13 includes an outer axial wall 17 furnished with a notch 18 for the connector 8 to pass through, a radial wall 19 extending inwards from an end of the axial wall 17 opposite to the notch 18, and an axial wall 20 of small diameter extending from the inside of the radial wall 19 in the same direction as the axial wall 17. The cap 13 also includes three axial posts 21 supported by the radial wall 19 on the side of the axial walls 17 and 20, and evenly distributed circumferentially.

During assembly, the intermediate support 12 and the electronic circuit board 1 are housed in the cap 13 with the posts 21 passing through the holes 15 of the support 12 and through the holes 7 of the electronic circuit board 1. The connector 8 protrudes radially outwards through the notch 18. The axial walls 17 and 20 of the cap 13 have an axial length that is greater than the thickness of the annular body of the support 12 and of the annular disc 4 of the electronic circuit board 1. The lugs 14 of the support 12, the tabs 3 and the sensors 11 protrude axially relative to the inner axial wall 20.

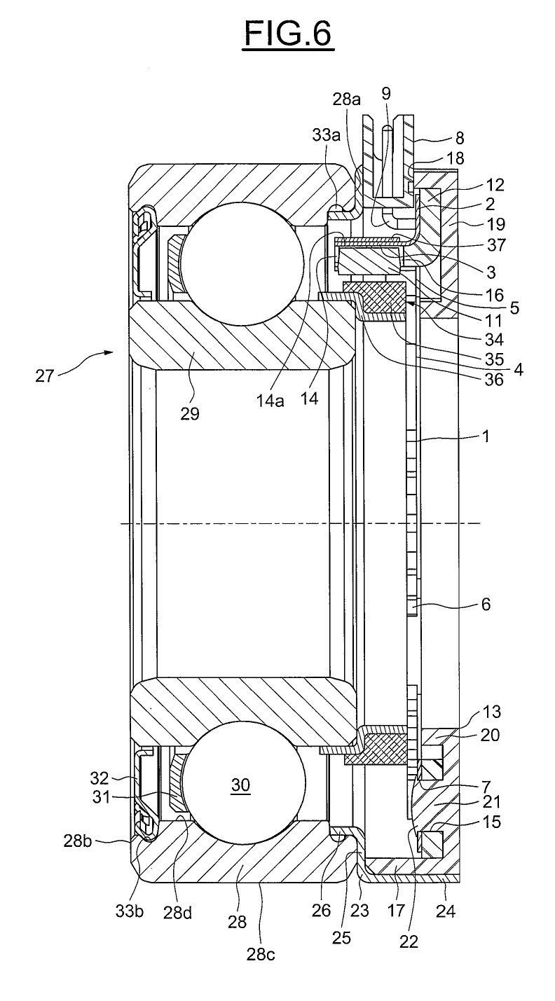

The electronic circuit board 1 and the sensor block formed by the support 12 and the cap 13 may then be fixedly attached in a particularly robust manner by deforming the posts 21 in the manner of rivets, for example by hot deforming. This causes the end of the posts 21 to widen to form a rivet head 22, see FIG. 6.

The sensor block and the electronic circuit board 1 may then be installed in a cup 23 of generally annular shape including an axial wall 24 of large diameter furnished with a bore into which the outer surface of the large diameter axial wall 17 of the cap 13 is fitted, a radial wall 25 extending inwards from the axial wall 24 and an axial rim 26 extending away from the axial wall 24 from the small diameter end of the radial wall 25, see FIG. 6. The cup 23 may be furnished with a notch to allow the connector 8 to pass through.

The assembly thus formed may be mounted onto a rolling bearing 27. The rolling bearing 27 includes an outer race 28, an inner race 29, a row of rolling elements 30 placed between the outer race 28 and inner race 29, a cage 31 for keeping the rolling elements 30 evenly spaced circumferentially and a sealing flange 32 fixed to the outer race 28 and forming a narrow passageway with the inner race 29. The outer race 28 may be symmetrical relative to a radial plane and have a transverse radial surface 28a on the side of the sensor block, a transverse radial surface 28b on the side of the sealing flange 32, an outer surface 28c and a bore 28d from which is arranged a raceway on the rolling elements 30. The outer race 33 includes two grooves 33a and 33b arranged from the bore 28d and close to the transverse surfaces 28a and 28b. One groove 33b of the two grooves is used for fixing the flange 32. The axial rim 26 of the cup 23 is fitted into the rim of the groove 33b, the radial portion 25 coming into contact with the transverse surface 28a of the outer race 28.

The inner race 29 supports a coder 34 including an active portion 35 and a support 36 fitted to an outer surface of the inner race 29. The support 36 may be in the form of an annular cup made of metal sheet. The active portion 35 may be overmoulded onto the outside of the support 36 and have an axial outer surface coming opposite the sensors 11 with a radial air gap.

In addition, to increase the rigidity of the tabs 3, it is possible to provide an enlarged thickness 37 increasing the thickness of the printed circuit 2 at the tabs 3 and locally stiffen the printed circuit in order to give it at the tabs a flat shape that it will tend to retain. The stiffening layer may consist, for example, of a layer of epoxy resin filled with glass fibres applied locally to the flexible substrate. The enlarged thickness 37 is placed on the side of the tabs 3 opposite to the sensors 11.

An instrumented rolling bearing is thus formed with a radial air gap and with a small axial space requirement because of the sensor 11 partly protruding into the space between the outer race 28 and inner race 29 and thanks to the fact that the electronic components 6 are housed in the sensor block in the axial space requirement of the sensors 11. In the same manner as the other electronic components, the sensors may be fixed to the printed circuit 2 by soldering, prior to the folding of the tabs, the said circuit then being flat. The method of installing the sensors and other electronic components may easily be automated with the aid of a robot by using the “Pick-and-place” technique.

In the position illustrated in FIG. 6, the sensors 11 are directly opposite the coder 34. It is possible in this way to prevent immersing the sensors 11 in a resin or a synthetic material, thereby saving time and labour and gaining a better signal supplied by the sensors 11.

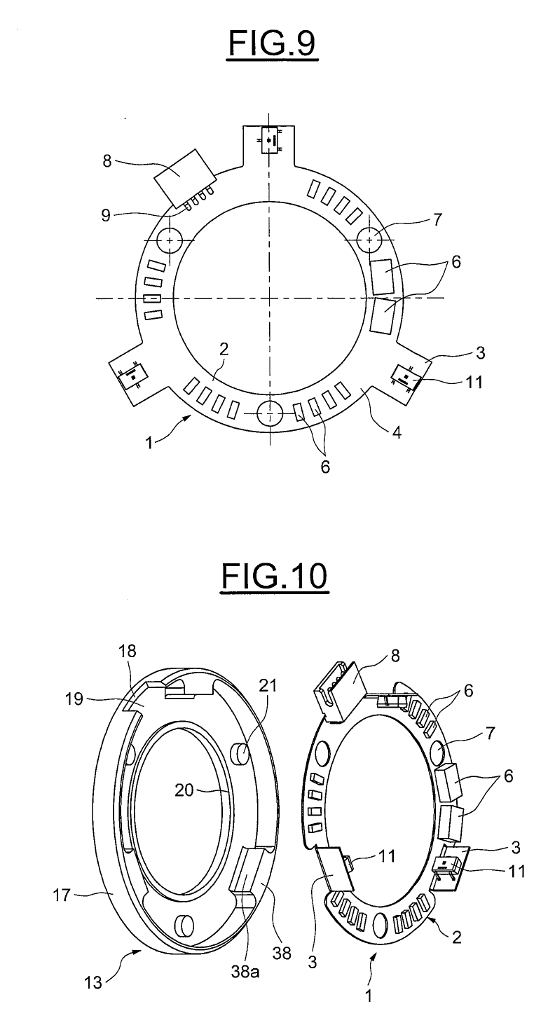

In the embodiment illustrated in FIGS. 7 to 11, the electronic circuit board 1 is similar to that of the preceding embodiment except that the tabs 3 protrude radially outwards from the annular disc 4 before folding. The presence of notches is not necessary. The sensors 11 and the electronic components 6 may be fixed to the same face of the printed circuit 2, see FIG. 9. The same applies to the connector 8.

From the intermediate state illustrated in FIGS. 7 to 9, the tabs 3 are folded at 90° and thereby become parallel to the axis of the annular disc 4. They are folded towards the side supporting the electronic components 6. After folding, the tabs have a flat shape.

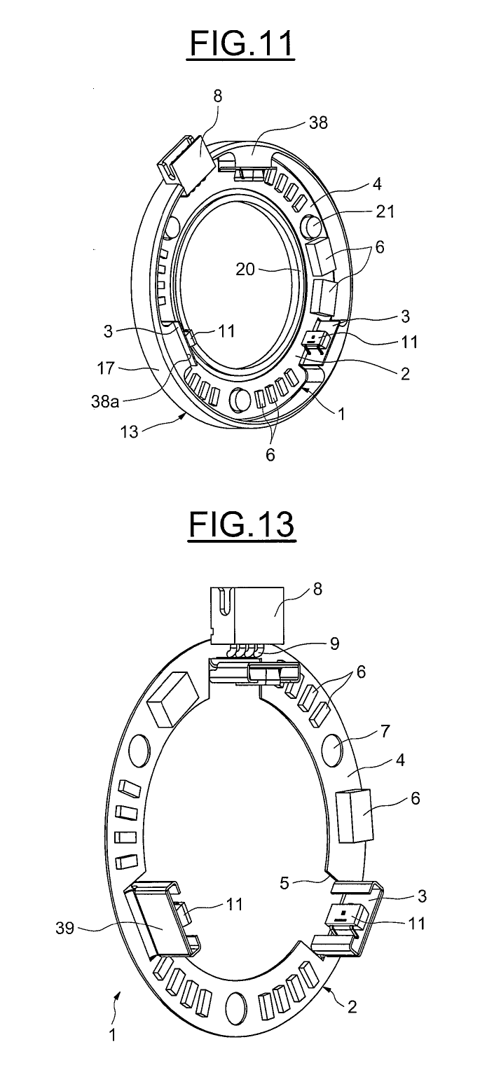

The electronic circuit board 1 may then be installed in the cap 13 that can be seen in FIGS. 10 and 11. The presence of an intermediate support is not indispensable. The cap 13 is similar to that illustrated previously except that the bore of the outer axial wall 17 is furnished with three protuberances 38 directed radially inwards and evenly spaced circumferentially while alternating with the posts 21. Each protuberance 38 has a radial thickness that is generally less than half the radial dimension of the radial wall 19 of the cap 13 and extends axially over all or some of the axial length of the axial wall 17. Each protuberance 38 has a reference surface 38a parallel to the axis of the cap 13 and of the electronic circuit board 1. The reference surfaces 38a may be normal to a radial straight line.

As can be seen in FIG. 10, the electronic circuit board 1 may be brought into the cap 13 by a simple axial movement. The connector goes into the notch 18. Each tab 3 is pressing against a flat reference surface 38a. The posts 21 go into the holes 7 to culminate in the state illustrated in FIG. 11. The posts 21 may then be deformed for the final attachment of the electronic circuit board in the cap 13. The tabs 3 may be held against the reference surfaces 38a by bonding, for example by placing a drop of adhesive on each reference surface 38a just before inserting the electronic circuit board 1 into the cap 13.

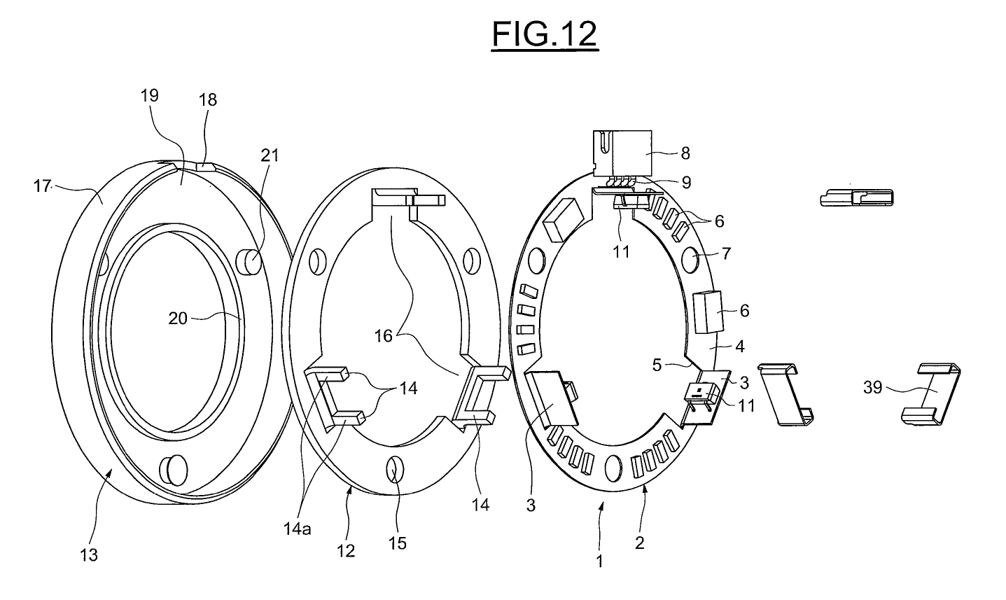

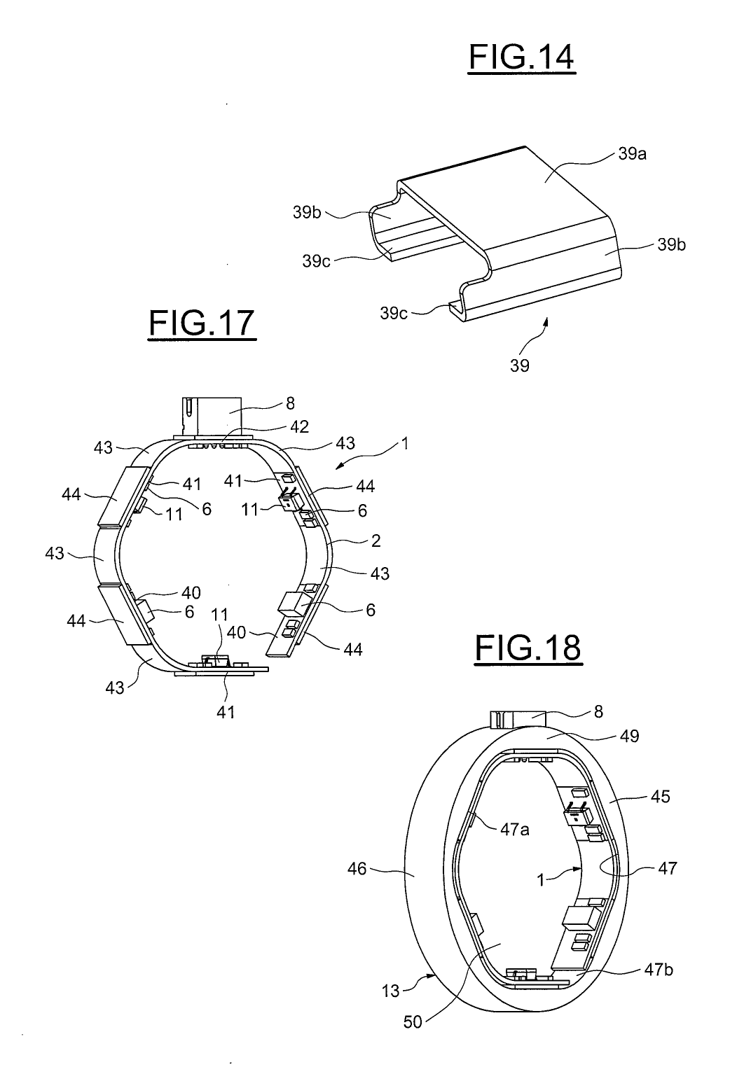

In the embodiment illustrated in FIGS. 12 to 14, the electronic circuit board 1, the intermediate support 12 and the cap 13 are identical to those of the first embodiment of FIGS. 1 to 6. Additionally, the flat tabs 3 are fixed to the lugs 14 of the intermediate support 12 by clips 39, see FIG. 14. A clip 39 is provided to lightly squeeze a tab 3 against the flat reference surfaces 14a of a pair of lugs 14. Folding a metal sheet blank may make the clips 39. A clip 39 is symmetrical relative to a central plane.

A clip 39 includes a rectangular body 39a from opposite ends of which two symmetrical wings 39b extend perpendicular to the body 39a. From the ends of the wings 39b away from the body 39a, two rims 39c extend parallel to the body 39a and turn inwards. The clips 39 may be pre-placed on the electronic circuit board 1 after the tabs 3 have been folded as illustrated in FIG. 13 or else be mounted after the electronic circuit board 1, the intermediate support 12 and the cap 13 have been assembled. The body 39a is in contact with the face of the tab 3 opposite to the sensor 11. The wings 39b surround the ends of the tabs 3 and an edge of the lugs 14. The rims 39c facing one another are pressing on an axial face of the lugs 14 opposite the reference surfaces 14a. A clip 39 lightly pinches the tab 3 of the printed circuit 2 against the reference surface 14a of the lugs 14, a tab 3 and a lug 14 being clipped between a rim 39c and the body 39a.

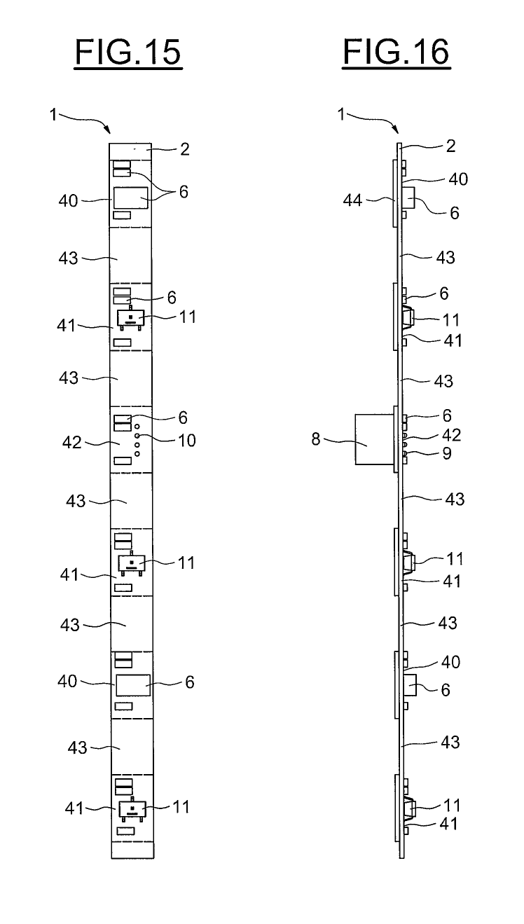

In the embodiment illustrated in FIGS. 15 to 19, the printed circuit 2 is in the form of a flat elongated rectangular strip in the intermediate state illustrated more particularly in FIGS. 15 and 16. The printed circuit 2 includes flat sections 40 supporting the electronic components 6, flat sections 41 each supporting a sensor 11 and if necessary electronic components 6, a flat section 42 supporting the connector 8 and, as appropriate, electronic components 6 and sections 43 with no electronic components or sensors. The sections 43 may naturally be furnished with printed conductor tracks linking the other sections. The sections alternate in the sense that a section 40, 41 or 42 is placed between two sections 43. The sections 40, 41 and 42 are reinforced by an enlarged thickness 44 similar to the reinforcement 37 illustrated in FIG. 6.

The sensors 11 and the electronic components 6 are placed on one face of the printed circuit 2. The connector 8 and the reinforcements 44 are placed on the opposite face.

The electronic circuit board 1 is then formed in order to give it the appearance illustrated in FIG. 17. The sections 43 with no components or sensors are folded with a relatively slight curvature and the sections 40 to 42 remain straight, particularly thanks to the reinforcement 44. This therefore gives a general shape of an open hexagon with the sensors 11 evenly distributed circumferentially substantially at 120 degrees. The electronic circuit 1 includes five bent sections 43 separating six straight sections, three sections 41 supporting a sensor 11, two sections 40 supporting electronic components 6 and one section 42 supporting the connector 8.

The electronic circuit 1 is then placed in a cap 13 of the type illustrated in FIG. 18, having the shape of a casing including a ring 45 provided with a circular outer surface 46 and an inner surface 47 matching the shape of the electronic circuit board 1 in its state illustrated in FIG. 17, in other words, in the shape of a hexagon with rounded corners, so that the reinforcements 44 placed on the outside of the sections 40, 41 and 42 are in contact with the inner surface 47 thereby providing an excellent positioning of the sensors 11 in the cap 13. The inner surface 47 includes straight portions 47a in contact with the reinforcements 44 and rounded portions 47b that can remain at a short distance from the bent sections 43. The reinforcements 44 may be fixed by bonding onto the portions 47a, which form the reference surfaces. The ring 46 includes two radial transverse surfaces of which the surface 49 can be seen in FIG. 18. A notch may be arranged to allow the connector 8 to protrude radially outwards from the ring 46.

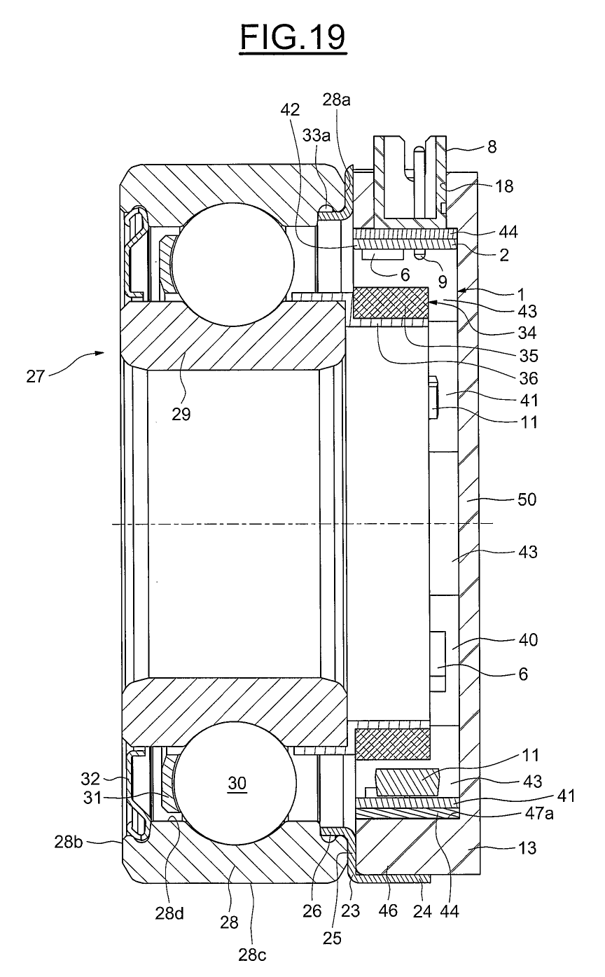

As illustrated in FIG. 19, the cap 13 also includes a radial wall 50 closing off an axial end of the ring 45 and placed on the side opposite to the cup 23 fixed in the groove 33a of the rolling bearing 27. The sensors 11 are placed on the inner face of the electronic circuit board 1, outside the active portion 35 of the coder 34 with a radial air gap as in the preceding embodiments. The sensors 11 are supported by straight sections 41 of the electronic circuit board 1 furnished with reinforcements 44 in contact with the straight surface 47a formed in the inner surface of the ring 47 of the cap 13, thereby forming reference surfaces. The reinforcement 44 may be bonded to the flat reference surfaces 47a in order to stabilize the positioning of the sensors 11.

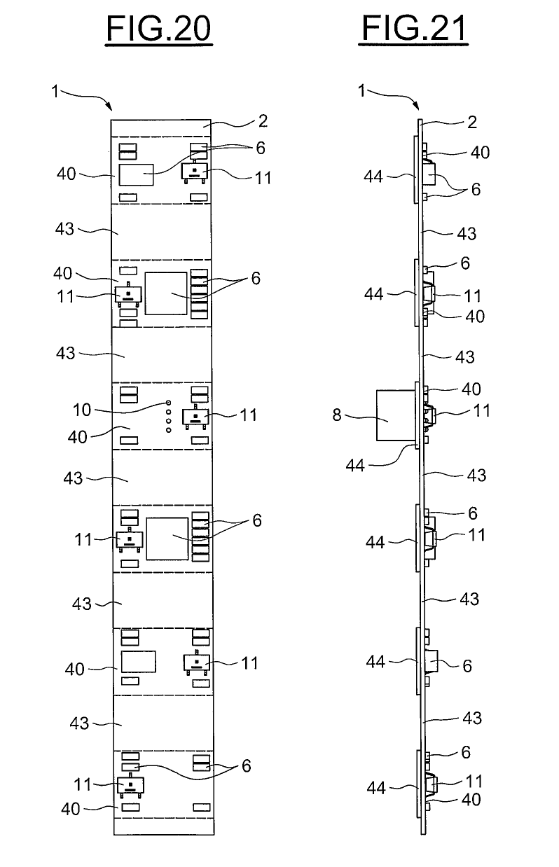

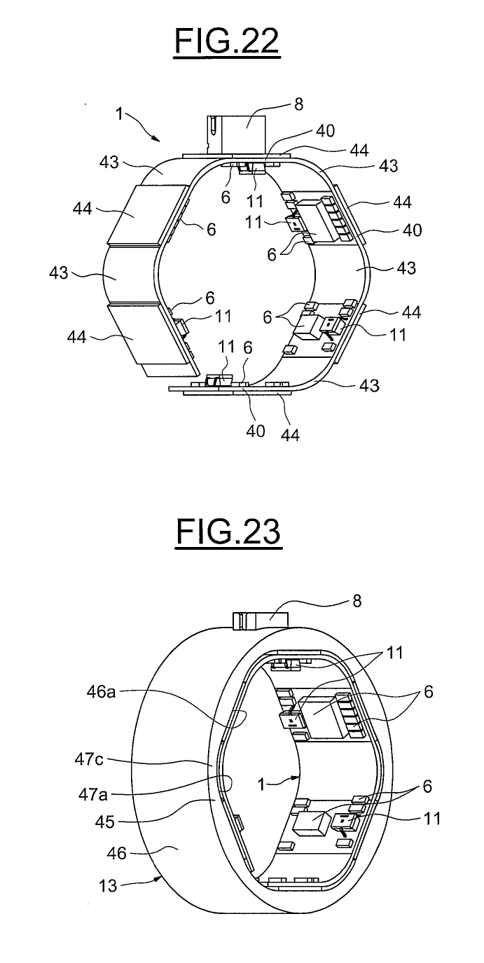

In the embodiment illustrated in FIGS. 20 to 24, the electronic circuit 1 is in a general form similar to that of the preceding embodiments, with a markedly increased, for example doubled, width, as can be seen in FIG. 20, in comparison with FIG. 15. The printed circuit 2 includes five sections 43 with no components and six flat sections 40 each supporting a sensor 11 and electronic components 6. One of the sections 40 also supports the connector 8. The sensors 11 are placed in two rows of three sensors 11 in an alternating manner, each portion 40 supporting a sensor 11. After the electronic circuit board 1 has been formed, see FIG. 22, the sensors 11 are distributed in two groups of three, each group being placed in one and the same radial plane, the two radial planes being offset axially relative to one another. Once formed, the electronic circuit board 1 is placed in the cap 13 having an annular shape similar to that of FIG. 18 but with a greater axial width to suit the increased axial width of the electronic circuit board of this embodiment.

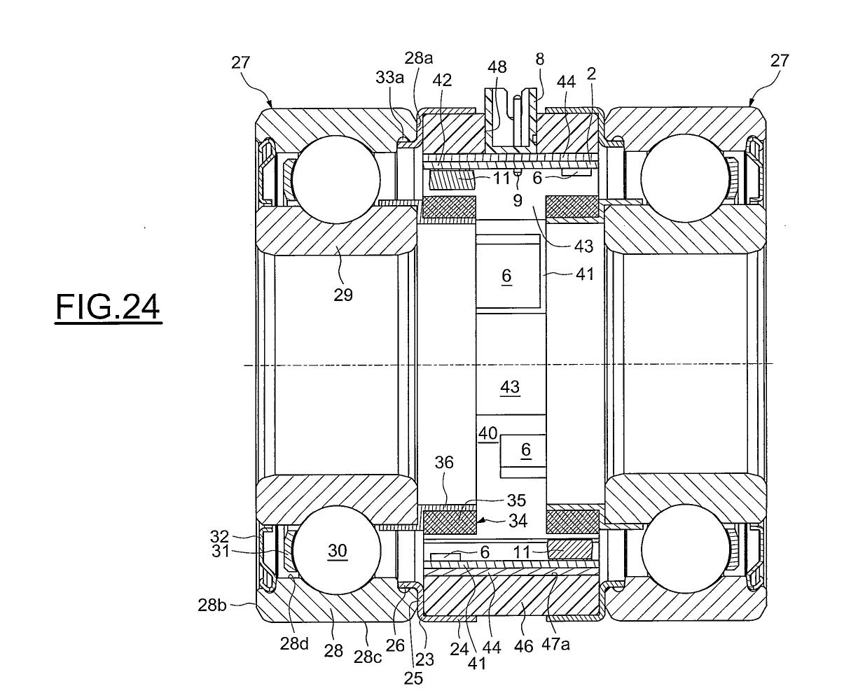

As can be seen in FIG. 24, the cap 13, with no radial wall, includes a window 48 allowing the connector 8 to protrude outwards. The cap 13 is designed to interact with two cups 23, each placed at an axial end of the cap 13. Each axial cup 23 is fixed to a rolling bearing 27. Therefore, the rolling bearing 27 whose outer races 28 are fixedly attached in rotation may be instrumented, each inner race 29 being furnished with a coder 34, each coder 34 supplying a magnetic signal to a group of sensors 11 dedicated to the said coder 34. In the embodiment shown, each group of coders 11 includes three coders 11. This gives an assembly of two instrumented rolling bearings with a small axial and radial space requirement and which is able to be manufactured at reasonable cost.

It is therefore easy to install all the electronic components and sensors on a printed circuit in an automated and economic manner, the electronic circuit board thus formed then being installed in a sensor block.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Instrumented rolling bearing device for measuring the rotation parameters of the bearing, comprising a rotating race, a non-rotating race, at least one row of rolling elements placed between the non-rotating and rotating races, a rotating coder and a non-rotating electronic circuit board supporting at least one sensor, wherein the board is pliable and comprises at least one flat folded zone supporting the said sensor and pressing on a rigid reference surface forming part of a sensor block, at least one sensor being in the form of a spot-type detector cell.

2. Device according to claim 1, in which the electronic circuit board also comprises electronic components for processing the signal transmitted by the sensor or sensors, the electronic components and the sensor or sensors being placed on one and the same face of the electronic circuit board.

3. Device according to claim 1, in which the electronic circuit board also comprises electronic components for processing the signal transmitted by the sensor or sensors, the electronic components, on the one hand, and the sensor or sensors, on the other hand, being placed on opposite faces in the electronic circuit board.

4. Device according to claim 1, in which the electronic circuit board also comprises a connector placed on one and the same face as the sensor or sensors or on the opposite face.

5. Device according to claim 1, in which the zone supporting the sensor is fixed to the reference surface by bonding.

6. Device according to claim 1, in which the pliable zone supporting the sensor is fixed to the reference surface by mechanical retention.

7. Device according to claim 6, in which the pliable zone supporting the sensor is fixed to the reference surface by a clip.

8. Device according to claim 1, comprising a sensor block fixed to the non-rotating race and supporting the electronic circuit board.

9. Device according to claim 8, in which the sensor block comprises a cap and an intermediate support furnished with at least one reference surface for the sensor or sensors, the cap being furnished with at least one element for positioning and retention of the intermediate support and of the electronic circuit board.

10. Device according to claim 8, in which the sensor block is furnished with at least one reference surface for the sensor or sensors and with at least one element for positioning and retention of the electronic circuit board.

11. Device according to claim 1, in which the electronic circuit board is, in the sensor block, in the form of a radial ring furnished with at least one axial lug forming a zone of support for the sensor.

12. Device according to claim 1, in which the electronic circuit board is, in the sensor block, in the form of an axial ring that is open or has joined ends.

13. Device according to claim 12, in which the electronic circuit board comprises bent portions and straight portions, the straight portions being furnished with reinforcements.

14. Device according to claim 12, comprising at least two rows of sensors placed in distinct radial planes.

15. Method of manufacturing an instrumented rolling bearing device for measuring the rotation parameters, comprising a rotating race, a non-rotating race, a row of rolling elements placed between the rotating and non-rotating races, a rotating coder and an electronic circuit board comprising at least one sensor, in which the said at least one sensor is fixed to the electronic circuit board, the electronic circuit board is formed by folding, and the said electronic circuit board is installed in a sensor block, a flat folded zone of the electronic circuit board supporting a sensor pressing on a rigid reference surface of the said sensor block.

16. Method according to claim 15, in which the electronic circuit board is fixed to the sensor block by material spinning of a portion of the sensor block.

17. Method according to claim 15, in which the said at least one sensor is fixed to a single face of the electronic circuit board.

18. Method according to claim 15, in which the zone of the electronic circuit board supporting the sensor is bonded to the reference surface.

19. Method according to claim 15, in which the zone of the electronic circuit board supporting the sensor is clipped to the reference surface.
